(19) United States
(12) Patent Application Publication
(10) Pub. No.: US 2004/0131911 A1
(43) Pub. Date: Jul. 8, 2004

(54) Fuel cell system having a pressure swing adsorption unit

(76) Inventors: Lars Kaufmann, Kirchheim (DE); Ian S Parker, Vancouver (CA); Andre J Boulet, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/468,529

(22) PCT Filed: Feb. 20, 2002
(86) PCT No.: PCT/CA02/00200

(30) Foreign Application Priority Data
Feb. 21, 2001 (DE) 10108187.1

(51) Int. Cl. H01M 8/04

(52) U.S. Cl. 429/34; 429/13

(57) ABSTRACT

The invention relates to a fuel cell system having a pressure swing adsorption (PSA) unit for enriching a reactant stream supplied to the fuel cell, and particularly for enriching an oxidant stream supplied to the fuel cell. The reactant stream flow is compressed in two stages, with one compressor arranged upstream and another compressor arranged downstream of the PSA unit. Further, for improved efficiency, a portion of the compressed reactant from the first stage may bypass the PSA and be combined with enriched reactant upstream of the second compression stage. A third compressor may be used for desorbing the PSA unit under vacuum. An energy recovery device may be employed in the oxidant exhaust line to recover energy in the oxidant exhaust, and the compressors and turbine may be arranged on a common shaft.

### FIELD OF THE INVENTION

The invention relates to fuel cell systems using pressure swing adsorption to provide enriched reactant to a fuel cell.

### BACKGROUND OF THE INVENTION

In fuel cells, hydrogen and oxygen react to form water, generating electric current in the process. The efficiency of the fuel cell is dependent, inter alia, on the purity of the reactants. Particularly on the cathode side of fuel cells operating on ambient air, considerable improvements are achieved if the natural 21% oxygen content in air is increased by suitable measures to levels over 30%.

One possible way of increasing the oxygen content in ambient air is to use a pressure swing adsorption (PSA) unit. When using PSA, the adsorption and desorption of gases at different pressures is used in a continuous cyclical process to increase the levels of a desired component. The pressure ratio between the starting gas mixture supplied and the exhaust gas which is to be discharged must be as high as possible in order to achieve efficient operation. This pressure ratio can be achieved either by means of a high admission pressure compared to ambient pressure on the starting gas mixture side or by means of a low admission pressure compared to ambient pressure on the starting gas mixture side and an additional vacuum on the exhaust gas side. The vacuum on the exhaust gas side can be produced, for example, by means of a vacuum pump. Furthermore, it may be desirable to keep the entry temperature of the PSA unit as low as possible for efficient operation. PSA units of this type have long formed part of the prior art.

Furthermore, it is known, in fuel cell systems, to use a PSA unit to increase the oxygen content in the supply of air to fuel cells. A fuel cell system with a PSA unit of this type is known, for example, from WO 00/16425, in which various embodiments are disclosed. In one example, the compressor on the starting gas mixture side is coupled via a common shaft to the vacuum pump on the exhaust gas side. A two-stage compressor on the starting gas mixture side is disclosed in a second example. The first stage is used to supply starting gas mixture to the PSA unit. The second stage is used to supply air to a catalytic burner, in which a fuel-containing exhaust gas from the fuel cell system is oxidized. The energy-rich exhaust gas from the catalytic burner is passed through a turbine which, in order to drive the two-stage compressor of the PSA unit, is arranged on a common shaft. In a third example, a compressor on the starting gas mixture side of a PSA unit is arranged on a common shaft with a vacuum pump on the exhaust gas side of the PSA unit and an exhaust gas turbine of the fuel cell system together with an additional electric drive motor.

### SUMMARY OF THE INVENTION

The invention provides for improved overall efficiency in a fuel cell system having a PSA unit. In one embodiment, a PSA unit is used to provide oxygen enriched air to the fuel cell in the system. The air stream supplied to the inlet of the PSA unit is compressed to a first pressure using a first compressor only to the extent required for enriching the air stream by pressure swing adsorption. This reduces the energy requirements of the first compressor and also reduces the temperature rise of the output compressed air. As a result of this more moderate temperature rise, it may not be necessary to cool the compressed air before supplying it to the PSA unit and thus a cooler may be dispensed with. After enrichment, a second compressor is used to further compress the enriched air stream in a second compression stage to a second pressure which is desirable for operation of the fuel cell. This method reduces the energy costs of the system because the volumetric flow which has to be compressed to the second pressure is reduced. The overall result is improved efficiency and an increased operating temperature for the fuel cell, since the fuel cell can be operated at a high oxygen content and, at the same time, at a high pressure.

Desorption of the PSA may be accomplished under a vacuum. As an alternative to using a separate vacuum pump, the exhaust gas from the PSA (e.g., the oxygen depleted air stream) may be compressed to ambient pressure by means of a third compressor which, together with the second compressor, is driven, via a common shaft, by a turbine arranged in the fuel cell oxidant exhaust flow. It may therefore be possible to dispense with a separate vacuum pump and its associated electric motor. At the same time, the reduction in energy consumption of the first compressor makes it possible for it to use a smaller electric motor.

A fuel oxidizing device may be incorporated in the oxidant exhaust line of the fuel cell. In addition, the fuel exhaust line from the fuel cell may be merged with the oxidant exhaust line upstream of the fuel oxidizing device. The arrangement of a fuel oxidizing device upstream of the turbine in the oxidant exhaust line allows the energy recovered from the fuel cell exhaust gas and therefore the power, which can be transmitted to the second and third compressors by the turbine to be increased or adjusted. Control is very simple by means of metering the fuel admitted to the oxidant exhaust line. A further advantage is that the anode exhaust gas may be used as fuel. Compared to oxidizing devices, such as burners with an open flame, the use of a catalytic burner allows improved exhaust emission values to be achieved.

A heat exchanger may be arranged downstream of the turbine in the oxidant exhaust line. This arrangement allows the thermal energy which is still present in the exhaust gas to be utilized even further, which leads to an improvement in the overall efficiency of the fuel cell system. If the fuel cell system includes a system for generating hydrogen from a liquid or gaseous crude fuel (e.g., a reformer system) the heat exchanger can be used to transfer energy to components of such a hydrogen generation system. By way of example, an evaporator or an endothermic reforming reactor can be heated in this way by means of the hot fuel cell exhaust gas.

In a second embodiment, as above, a reactant stream may initially be compressed to a first pressure suitable for enriching the reactant stream by pressure swing adsorption, then enriched using the PSA unit and then compressed to a second pressure suitable for operation of the fuel cell. However if the desired level of enrichment for fuel cell operation is less than that readily achieved using the PSA unit, it may be advantageous for system efficiency to “overenrich” the reactant stream in the PSA and then combine it with additional unenriched reactant before the second compressing stage. That is, this method involves compressing the reactant stream to the first pressure, enriching a first portion of the compressed reactant stream in the pressure swing adsorption unit, mixing the enriched reactant stream portion with an additional reactant stream portion, and compressing the mixture of enriched reactant stream and additional reactant stream to the second pressure before supplying the compressed mixture to a reactant inlet of the fuel cell.

An apparatus for the second embodiment may thus comprise a fuel cell, first and second compressors, and a PSA unit. A first supply line for a reactant stream connects to an inlet of the first compressor. The PSA unit comprises an inlet connected to an outlet of the first compressor. The PSA unit also comprises an enriched reactant stream outlet and a depleted reactant stream outlet. The second compressor comprises an inlet connected to the enriched reactant stream outlet of the PSA unit, and an outlet connected to a reactant stream inlet of the fuel pell. A second supply line which supplies the additional reactant stream portion is also connected to the inlet of the second compressor.

A second portion of the compressed, but unenriched, reactant stream from the first compressor may be used as the additional reactant stream portion. The second reactant stream supply line may thus be a bypass line connecting the outlet of the first compressor to the inlet of the second compressor, thereby bypassing the pressure swing adsorption unit. A split stage compressor may advantageously be used for compressing the reactant stream to the first pressure and then for compressing the mixture to the second pressure.

Coolers may optionally be employed in the fuel cell system to suitably cool the first portion of the compressed reactant stream before enriching in the pressure swing adsorption unit, and/or suitably cool the compressed mixture before supplying the mixture to a reactant inlet of the fuel cell. Similarly, a heat exchanger may be used to heat the compressed mixture if desired before supplying the mixture to a reactant inlet of the fuel cell. The heating medium could be the oxidant exhaust line from the fuel cell.

The PSA unit may be operated at a desorbing pressure below atmospheric pressure (a pressure-vacuum swing). This may be accomplished by employing a third compressor connected to the depleted reactant stream outlet of the PSA unit.

Such methods and apparatus are particularly useful in fuel cell systems comprising solid polymer electrolyte fuel cells and those in which the reactant stream to be enriched is air. Efficiency improvements may be achieved without recirculating a reactant stream exhausted from the fuel cell (i.e. without supplying part of the fuel cell reactant exhaust stream back to the fuel cell reactant inlet).

### BRIEF DESCRIPTION Of THE DRAWINGS

FIG. 1 is a schematic diagram of a first embodiment of a SA-fuel cell system having improved efficiency.

FIG. 2 is a schematic diagram of a second embodiment of a PSA-fuel cell system having improved efficiency.

### DETAILED DESCRIPTION OF THE PREFERRED EMBODIMENTS

The invention will now be described in more detail with reference to the Figures, which show two schematic diagrams of efficient fuel cell systems having pressure swing adsorption units.

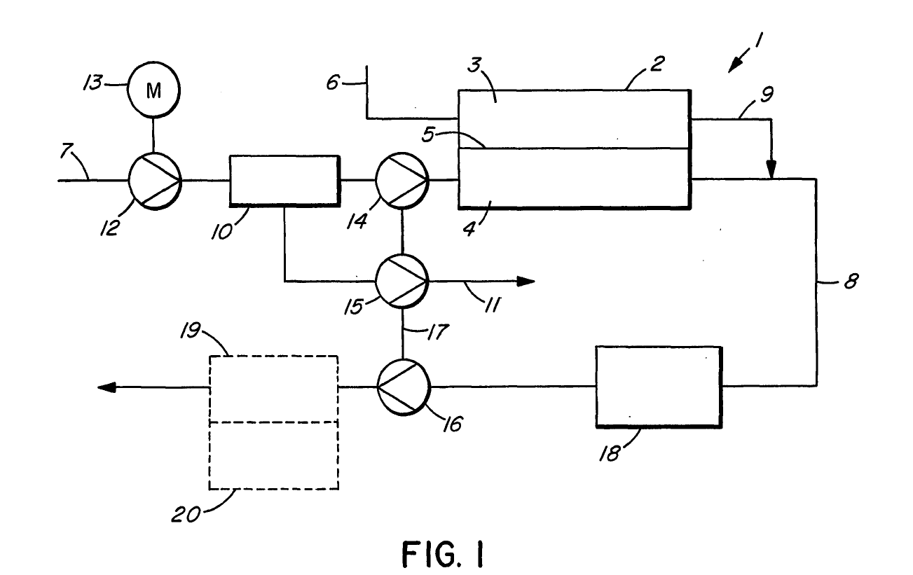

In FIG. 1, fuel cell system 1 includes fuel cell 2, which is operated on oxygen-enriched air. Fuel cell 2 is preferably a solid polymer electrolyte or PEM type of fuel cell, which has anode chamber 3 and cathode chamber 4 separated by proton-conducting membrane electrolyte 5. Fuel cell 2, which is only diagrammatically illustrated, is preferably a fuel cell stack comprising a plurality of fuel cells and may be assembled using prior art methods. In the following, the invention is described with respect to a single PEM fuel cell. However, this should not be construed as restricting the scope of protection to this specific exemplary embodiment.

Anode chamber 3 is supplied with a hydrogen-rich gaseous fuel stream via fuel supply line 6, and this gas, after it has flowed through anode chamber 3, is exhausted via fuel exhaust line 9. At the same time, cathode chamber 4 is supplied, via oxidant supply line 7, with an oxygen-containing gaseous oxidant stream which, after it has flowed through cathode chamber 4, is exhausted via oxidant exhaust line 8. In fuel cell 2, some of the hydrogen in the fuel stream reacts in a known way with some of the oxygen in the oxidant stream, to form water while generating heat and electric current.

Pressure swing adsorption (PSA) unit 10 is arranged in oxidant supply line 7 to increase the oxygen content in the oxidant stream. PSA units 10 of this type are generally known in the prior art. Therefore, the way in which they operate will only be described briefly below. In a PSA unit, a starting gas mixture is generally divided into an enriched product gas flow and a depleted exhaust gas flow. The degree of enrichment is decisively influenced by the pressure difference between the starting gas mixture and the depleted exhaust gas. Therefore, the PSA unit can be operated either at a high pressure in the starting gas mixture line and/or a high vacuum in the depleted exhaust gas line. In FIG. 1, an air stream is supplied to PSA unit 10 via oxidant supply line 7. Then, the oxygen-enriched product gas is, likewise supplied, via oxidant supply line 7, to cathode chamber 4 of fuel cell 2. Depleted exhaust gas from PSA unit 10 is exhausted via depleted oxidant exhaust gas line 11.

First compressor 12, which is driven with the aid of electric motor 13, is arranged in oxidant supply line 7, upstream of PSA unit 10. With the aid of first compressor 12, the air stream is compressed only to the extent required for PSA unit 10. Moreover, the air stream is only compressed to such an extent that the associated temperature rise may not be enough to require cooling and hence a cooler. Instead, the compressed air can be supplied to PSA unit 10 in an uncooled state. The product gas which has been enriched in PSA unit 10 is then supplied to cathode chamber 4 of fuel cell 2 via oxidant supply line 7. In oxidant supply line 7, second compressor 14 is arranged between PSA unit 10 and fuel cell 2. With the aid of second compressor 14, the enriched product gas is compressed further to the pressure level required for fuel cell 2 (e.g. 2.5 to 5 bar absolute). This requires less compression energy than conventional systems, since the entire volumetric flow of the original supplied air stream does not need to be compressed. Instead, only the product gas from PSA unit 10, which has already been enriched and from which nitrogen has been partly removed, needs to be compressed to the fuel cell pressure level.

Third compressor 15 is provided in depleted oxidant exhaust line 11 to compress or pump depleted oxidant exhaust from PSA unit 10. The depleted oxidant in PSA unit 10 is preferably under a vacuum (e.g. 0.5 to 0.9 bar absolute) and is compressed substantially to ambient pressure by third compressor 15. Finally, turbine 16 is arranged in oxidant exhaust line 8 in order to recover energy from the fuel cell exhaust gas. Turbine 16 is arranged on common shaft 17 together with second compressor 14 and third compressor 15, such that second and third compressors 14, 15 may be driven by turbine 16. If the energy which is present in the fuel cell exhaust gas is not sufficient to drive first and second compressors 14, 15, it is additionally possible to provide fuel oxidizing device 18 in oxidant exhaust line 8 between fuel cell 2 and turbine 16. In fuel oxidizing device 18, a fuel stream supplied upstream is oxidized. For instance, fuel exhaust line 9 may connect to oxidant exhaust line 8 upstream of fuel oxidizing device 18, so that the anode exhaust gas from fuel cell 2 can be oxidized in device 18. Fuel oxidizing device 18 is preferably a catalytic burner. The use of a catalytic burner makes it possible to ensure improved exhaust gas emission values in the system. In principle, however, it is possible to use any other suitable fuel oxidizing device, for example a burner with an open flame.

If improved control of the output of turbine 16 is required, this can easily be ensured by suitable metering of additional fuel into fuel oxidizing device 18 (not shown in FIG. 1).

A fuel cell system of the type depicted in FIG. 1 is suitable both for operation on pure hydrogen and for operation on hydrogen generated from a gaseous or liquid crude fuel by means of a fuel gas generating system (e.g. a reformer system). In the latter case, however, it is additionally possible for energy remaining in the fuel cell exhaust gas in oxidant exhaust line 8 downstream of turbine 16 to be transferred via heat exchanger 19 to some suitable component 20 in the fuel gas generating system. This allows the overall efficiency of fuel cell system 1 to be improved further. Any component 20 in the fuel gas generating system which has a need for heat, for example evaporators or reforming components, may be suitable in this regard.

In principle, any machine capable of compressing gas while consuming energy may be suitable for use as a compressor in the fuel cell system. In principle, any energy recovery unit which can provide mechanical energy through the expansion of a gas may be suitable for use as a turbine. First and second compressors 14, 15, which are arranged on common shaft 17 with turbine 16, are preferably designed as turbo chargers.

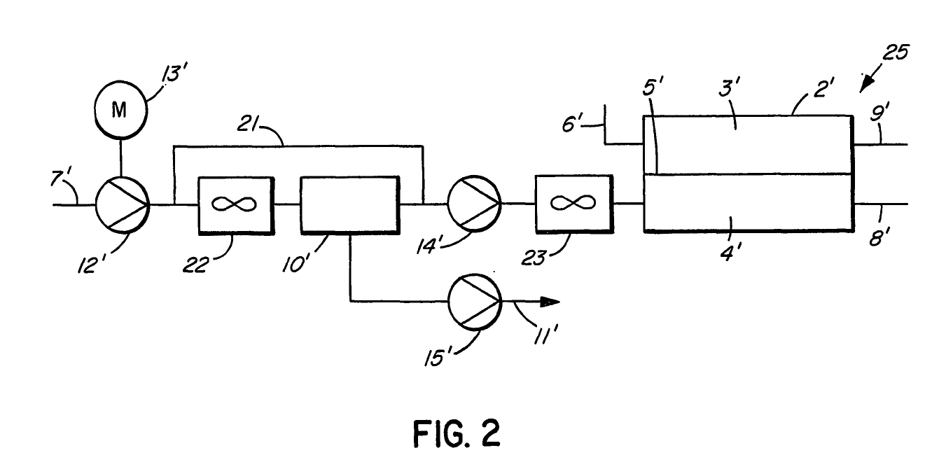

A second possible embodiment of a PSA-fuel cell system having improved efficiency is depicted in the schematic diagram of FIG. 2. Certain components in FIG. 2 are similar to those in FIG. 1 and have been identified with like numerals followed by the prime symbol (e.g. anode chamber 2 in FIG. 1 is similar to anode chamber 2′ in FIG. 2). Fuel cell 2′ in fuel cell system 25 also operates on oxygen-enriched air provided from PSA unit 10′. In system 25, air is directed to the inlet of first compressor 12′ via oxidant supply line 7′ and is compressed to a first pressure suitable for enrichment using PSA unit 10′. However here, only a first portion of the compressed air is directed to PSA unit 10′. The remaining second portion bypasses PSA unit 10′ via bypass line 21. The bypassed second portion is not enriched and is combined with the enriched first portion prior to compressing the mixed portions to a second pressure preferred for fuel cell operation. The portions may be combined using a venturi or eductor system designed for overall efficiency (not shown in FIG. 2) with the enriched first portion from PSA unit 10′ supplied into the lower pressure region of the venturi. The relative amount of the enriched and bypassed portions may be adjusted to suit a particular system by appropriate use of valving or the like (not shown in FIG. 2 but typically located where oxidant supply line 7′ intersects bypass line 21).

As depicted in FIG. 2, the temperature of the compressed air after compressing to the first pressure is higher than that desired for pressure swing adsorption. Thus, the first portion of compressed air (directed to PSA unit 10′) is cooled appropriately by first cooler 22 before entering the PSA unit inlet. The enriched oxidant stream produced by PSA unit 10′ is then directed to second compressor 14′ where it is mixed with the bypassed second portion of unenriched, compressed air via bypass line 21. Desorption in PSA unit 10′ may be performed under vacuum as is shown here, and thus compressor 15′ is provided in depleted oxidant exhaust line 11′ to remove depleted oxidant from PSA unit 10′.

The mixture of the enriched first portion and the unenriched second portion is then further compressed by second compressor 14′ to a preferred second pressure for operating the fuel cell. Again as depicted, the temperature of the compressed air after compressing to the second pressure is higher than that desired for fuel cell operation. Thus, a second cooler 23 appears in oxidant supply line 7′ to reduce the temperature before finally directing the enriched oxidant stream to cathode chamber 4′.

The embodiment of FIG. 2 offers several advantages over prior art PSA-fuel cell systems. Again, nitrogen removed from the oxidant stream by PSA unit 10′ is not compressed to the higher second pressure desired for fuel cell operation. This reduces the overall compressor power required. Further, with a reduction in compressor power, the net cooling load in system 25 may be reduced accordingly. Advantageously, the temperature of the compressed stream supplied to PSA unit 10′ may be different than that of the stream supplied to fuel cell 2′ since the streams are significantly decoupled. In particular, the temperature of the stream supplied to PSA unit 10′ may be lower generally permitting operation of PSA unit 10′ at a lower temperature. Further still, PSA unit 10′ may be operated in a higher efficiency, higher purity mode (i.e. higher purity than that supplied to fuel cell 2′), which may be beneficial to the system overall.

Although shown separately in FIG. 2, compressors 12′ and 14′ may be comprised within a single split stage compressor. The part of the system consisting of cooler 22 and PSA unit 10′ in FIG. 2 then also serves as an interstage cooler for the split stage compressor.

With suitable adaptations, the embodiment of FIG. 2 may be considered for use with various fuel cell types and other reactant streams. However, it is particularly useful for solid polymer electrolyte fuel cell systems operating on oxygen-enriched air, as illustrated in the following example.

### EXAMPLE

A modeling analysis was performed on an improved PSA-fuel cell system like that shown in FIG. 2 and was compared to that of a conventional system. A computer based gas process modeling system was used for this purpose. The improved system was assumed to employ an efficient rotary PSA unit for oxygen enrichment operating using a pressure-vacuum swing cycle and a solid polymer electrolyte fuel cell provided with an oxygen-enriched air stream with 40% O₂. A vacuum pump was used for third compressor 15′ to provide a lower desorption pressure of about −5 psig in the pressure-vacuum swing cycle. (The vacuum pressure may be controlled from atmospheric to 10 psig (1.0 to 0.3 bara) depending on the PSA operating range and the required oxidant enrichment.) It was assumed that ambient air was the oxidant supply available. Also, a split stage compressor comprising first and second compressors 12′ and 14′ was employed.

The conventional system was assumed to be similar and to provide similar quality oxidant to the fuel cell except that, in the conventional system, the entire oxidant stream was compressed to the fuel cell oxidant inlet pressure (i.e. the second pressure) prior to enrichment, no second cooler was employed, and the PSA unit desorbed at ambient pressure (i.e. vacuum swing was not employed, although a similar absolute pressure ratio for adsorption/desorption was used).

In the improved system, the first compressor stage provides compressed air at about 15 psig (2.1 bara) and 90° C. About half of the volume (first portion) is directed to the first cooler and then to the PSA unit, while the remainder of the volume (second portion) bypasses the PSA unit. The first portion of compressed air (about 21% O₂) is cooled to about 50° C. and directed to the PSA unit. The first portion is enriched using a pressure-vacuum adsorption cycle to yield a stream of about 80% O₂, 15 and 50° C. The enriched first portion is combined with the second unenriched portion in the split stage compressor and compressed in the second stage to yield a mixture about 40% O₂, 30 psig, and 150° C. Finally, this mixture is cooled in the second cooler to about 100° C. to yield a preferred, enriched oxidant supply for the fuel cell.

Compared to the conventional system, the improved bypass system is expected to save approximately 25-30% of the energy in overall compressor power. Further, the required surface area and capacity of the cooling systems in the improved system is reduced by an amount commensurate with the reduction in compressor power requirement. While the improved system may require a vacuum pump which represents an additional power drain compared to the conventional system, the energy requirements of the vacuum pump are expected to be substantially less than the savings obtained in compressor power. Thus, a significant improvement in overall system efficiency is expected.

It should also be noted that while the PSA unit in the improved system of this example used the adsorption/desorption pressure ratio of the conventional system, a higher overall pressure ratio may instead be considered. This would provide improved performance to the PSA and would allow a net reduction in compressor power requirement and cooling load. This will permit a reduction in the size and area of the coolers or alternatively a reduction in cooler approach temperatures.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A fuel cell system comprising a fuel cell supplied with enriched oxidant, the fuel cell system comprising an oxidant supply line, an oxidant exhaust line, a fuel supply line, a fuel exhaust line, a pressure swing adsorption unit arranged in the oxidant supply line and comprising a depleted oxidant exhaust line, a first compressor arranged in the oxidant supply line upstream of the pressure swing adsorption unit, a second compressor arranged in the oxidant supply line between the pressure swing adsorption unit and the fuel cell, a third compressor arranged in the depleted oxidant exhaust line downstream of the pressure swing adsorption unit, and a turbine arranged in the oxidant exhaust line, wherein the second compressor, the third compressor and the turbine are arranged on a common shaft.

2. The fuel cell system of claim 1 comprising a fuel oxidizing device arranged in the oxidant exhaust line between the fuel cell and the turbine.

3. The fuel cell system of claim 2 wherein the fuel exhaust line is connected to the oxidant exhaust line upstream of the fuel oxidizing device.

4. The fuel cell system of claim 2 wherein the fuel oxidizing device is a catalytic burner.

5. The fuel cell system of claim 1 comprising a heat exchanger arranged in the oxidant exhaust line downstream of the turbine.

6. The fuel cell system of claim 1 wherein the first compressor is electrically driven.

7. A fuel cell system comprising:
a fuel cell;
a first compressor;
a first supply line for a reactant stream connected to an inlet of the first compressor;
a pressure swing adsorption unit comprising an inlet connected to an outlet of the first compressor, an enriched reactant stream outlet, and a depleted reactant stream outlet;
a second compressor comprising an inlet connected to the enriched reactant stream outlet of the pressure swing adsorption unit, and an outlet connected to a reactant stream inlet of the fuel cell; and
a second supply line for the reactant stream connected to the inlet of the second compressor.

8. The fuel cell system of claim 7 wherein the second reactant stream supply line is a bypass line connecting the outlet of the first compressor to the inlet of the second compressor and bypassing the pressure swing adsorption unit.

9. The fuel cell system of claim 8 wherein the first and second compressors are comprised within a split stage compressor.

10. The fuel cell system of claim 7 wherein the reactant stream comprises oxidant.

11. The fuel cell system of claim 10 wherein the reactant stream comprises air.

12. The fuel cell system of claim 7 comprising a first cooler between the outlet of the first compressor and the inlet of the pressure swing adsorption unit.

13. The fuel cell system of claim 7 comprising a second cooler between the outlet of the second compressor and the reactant stream inlet of the fuel cell.

14. The fuel cell system of claim 7 comprising a third compressor connected to the depleted reactant stream outlet of the pressure swing adsorption unit.

15. The fuel cell system of claim 7 wherein the fuel cell is a solid polymer electrolyte fuel cell.

16. A method for efficiently operating a fuel cell system comprising a fuel cell and a pressure swing adsorption unit, the method comprising:
compressing a reactant stream to a first pressure suitable for enriching the reactant stream by pressure swing adsorption;
enriching a first portion of the compressed reactant stream in the pressure swing adsorption unit;
mixing the enriched reactant stream portion with an additional reactant stream portion;
compressing the mixture of enriched reactant stream and additional reactant stream to a second pressure suitable for operation of the fuel cell; and
supplying the compressed mixture to a reactant inlet of the fuel cell.

17. The method of claim 16 comprising using a second portion of the compressed reactant stream for the additional reactant stream portion.

18. The method of claim 16 comprising using a split stage compressor for compressing the reactant stream to the first pressure and for compressing the mixture to the second pressure.

19. The method of claim 16 wherein the reactant stream comprises oxidant.

20. The method of claim 19 wherein the reactant stream comprises air.

21. The method of claim 16 comprising cooling the first portion of the compressed reactant stream before enriching in the pressure swing adsorption unit.

22. The method of claim 16 comprising cooling the compressed mixture before supplying the mixture to a reactant inlet of the fuel cell.

23. The method of claim 16 comprising operating the pressure swing adsorption unit at a desorbing pressure below atmospheric pressure.

24. The method of claim 16 wherein the reactant exhausted from the fuel cell is not recirculated.
